(19) United States
(12) Patent Application Publication
(10) Pub. No.: US 2019/0047429 A1
(43) Pub. Date: Feb. 14, 2019

(54) System and Method for Rapid Charge Battery Cooling Station

(71) Applicant: Valvoline Licensing and Intellectual Property LLC, Lexington, KY (US)

(72) Inventors: Jeffrey Robert Torkelson, Lexington, KY (US); Frances E. Lockwood, Georgetown, KY (US)

(73) Assignee: Valvoline Licensing and Intellectual Property LLC, Lexington, KY (US)

(21) Appl. No.: 16/058,619

(22) Filed: Aug. 8, 2018

Related U.S. Application Data
(60) Provisional application No. 62/544,481, filed on Aug. 11, 2017.

(51) Int. Cl. B60L 11/18; H01M 10/613; H01M 10/633; H01M 10/625

(52) U.S. Cl. CPC B60L 11/1824; B60L 11/1874; B60K 6/28; H01M 10/633; H01M 10/625; H01M 10/613

(57) ABSTRACT

Systems and methods are described for a battery charging station including a charger connected with a battery of a vehicle, and a cooling system connected external to the vehicle. The cooling system is connected with the vehicle during charging of the battery to prevent overheating of the battery during charging.

### CROSS-REFERENCE TO RELATED APPLICATIONS

This application claims the benefit of U.S. Provisional Application Ser. No. 62/544,481, filed Aug. 11, 2017, which is incorporated in its entirety herein.

### TECHNICAL FIELD

This disclosure generally relates to systems and methods for charging batteries, and more particularly to cooling batteries during charging.

### BACKGROUND

Electric vehicles, also called an electric drive vehicles, can use one or more electric motors or traction motors for propulsion. Electric vehicle may be powered with, among other things, one or more batteries that are charged by a charger external to the vehicle. Another type of electric vehicle, a hybrid vehicle, utilizes more than one form of onboard energy to achieve propulsion. The hybrid vehicle can also include one or more electric motors and batteries, as well as an internal-combustion engine and a fuel tank. Batteries of hybrid vehicles can also be charged by a charger external to the vehicle.

### SUMMARY

According to one aspect, systems and methods provide a battery charging station including a charger connected with a battery of a vehicle, and a cooling system connected external to the vehicle. The cooling system can help prevent overheating of the battery during charging.

Other systems, methods, features, and advantages is or will become apparent upon examination of the following figures and detailed description. It is intended that all such additional systems, methods, features, and advantages be included within this description and be protected by the accompanying claims.

### BRIEF DESCRIPTION OF THE DRAWINGS

FIG. 1 is a schematic of an example charging vehicle station.

FIGS. 2A and 2B are block diagrams of example drive trains of the vehicle.

FIG. 3 is a flowchart of an example process for charging batteries.

FIG. 4 is a block diagram of an example computing device.

### DETAILED DESCRIPTION

This disclosure generally relates to systems and methods for charging vehicle batteries, e.g., batteries of electric and/or hybrid vehicles. More particularly, the systems and methods can control cooling of the batteries to prevent overheating when charging the batteries, e.g., when rapid charging batteries with high voltages. Overheating of the batteries can degrade the batteries and/or shorten the life of batteries, among other things.

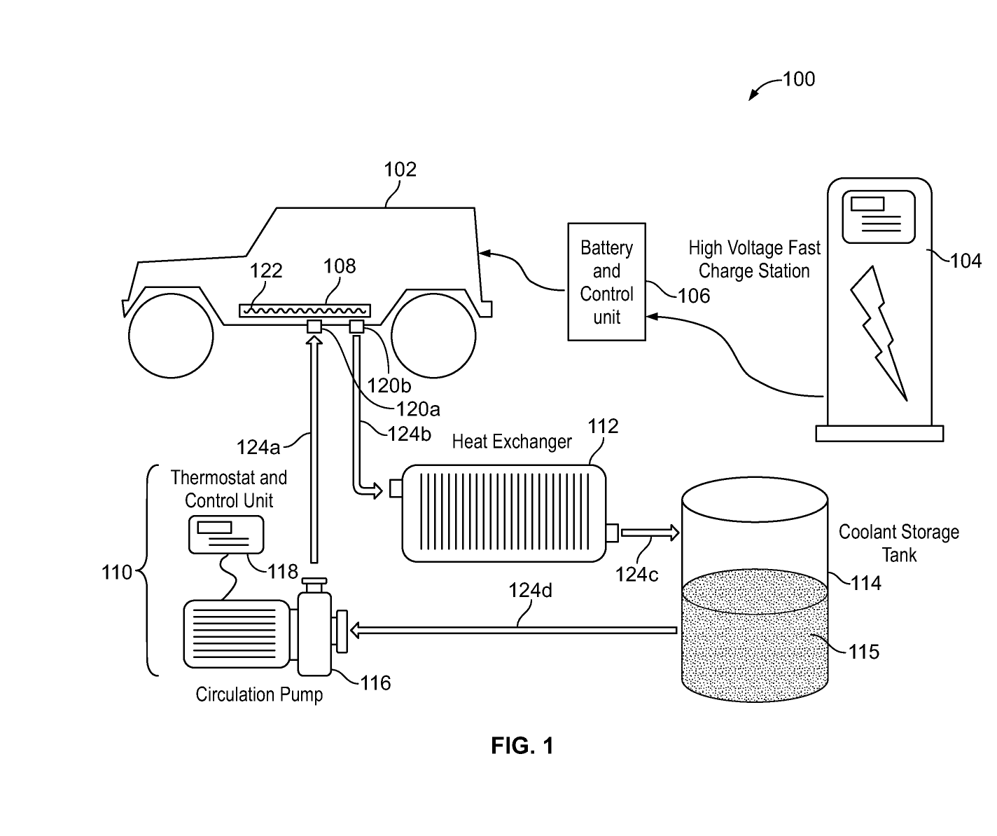

FIG. 1 is a schematic of an example vehicle charging station 100. In some examples, the vehicle charging station 100 includes a vehicle 102 having a battery 108 to be charged and a charger 104. The vehicle 102 can include various types of vehicles, including but not limited to, an electric vehicle, a hybrid vehicle or some other mechanism with one or more batteries 108 to be charged. In some examples, the vehicle 102 includes one or more road or other surface vehicles, including but not limited to cars, trucks, buses, recreation vehicles, etc., rail vehicles, water vehicles, e.g., boats, etc., air vehicles, e.g., airplanes, drones, etc., and spacecraft, etc. In some examples, the charger 104 provides a high voltage, rapid charging of the battery 108. A control unit 106 can connect with the charger 102 and the vehicle 102, e.g., to control a type of charge delivered from the charger 104 to the battery 108. The control unit 106 can be provided internal to and/or external to the vehicle 102. The type of charge can depend on whether or not the battery 108 is connected with a cooling system 110.

In some examples, the cooling system 110 includes one or more of heat exchanger(s) 112, coolant tank(s) 114 to store coolant 115, circulation pump(s) 116, thermostat and control unit(s) 118 and hoses 124a, b, c, d. More or less components than shown can be included in the cooling system 110. In some examples, multiple heat exchangers 112/pumps 116 can be connected with a single coolant tank 114, multiple coolant tanks 114 can be connected with a single heat exchanger 112/pump 116, and/or multiple coolant tanks 114 can be connected with multiple heater exchanger 112/pumps 116, etc., and any variation thereof. The pump 116 supplies coolant 115 from the coolant storage tank 114 to the battery 108 of the vehicle 102. The heat exchanger 112 removes heat from the coolant 115 before the coolant 115 is returned to the coolant storage tank 114. Additionally or alternatively, the heat exchanger 112 can be positioned after the coolant storage tank 114 to remove heat from the coolant at that stage. The circulation pump(s) 116, heat exchanger(s) 112 and/or the thermostat and control unit 118 can be provided internal and/or external to the vehicle 102.

Hoses 124a, b can releasably connect the pump 116 and the heat exchanger 112 with the cooling circuit/cells 122 of the battery 108, e.g., via connectors 120a, b. In some examples, the cooling circuit/cells 122 can include cooling channels and/or plates, etc., for circulating coolant near, through and/or around the battery 108. In some examples, the cooling circuit/cells 122 are the same as the cooling system native to the vehicle 102. The coolant 115 can be the same, or equivalent to, the coolant native to the cooling system of the vehicle 102. In some examples, the cooling circuit/cells 122 includes a separate cooling circuit from the cooling system native to the vehicle 102. In some examples, the connectors 120a, b include quick release connectors. Other types of connectors may be used. In some examples, the connector 120a, b are of varying types and/or sizes to connect with different types and/or sizes of cooling/battery systems. In some examples, the connectors 120a, b are universal type connectors.

During charging of the batteries 108 of the vehicle 102, heat can be generated in the batteries 108 that can damage to the batteries 108 and/or potentially cause fires if the heat is not properly controlled. To overcome these risks the batteries 108 can be charged relatively slowly with a low voltage power source. In some examples, the slow charge can take hours, and may be suitable in some situations, but may not be convenient in other situations. For example, the vehicle 102 may be needed again quickly at home or work, and/or a rapid charge may be provided in some scenarios, e.g., while the vehicle 102 is being serviced for an oil change. To control an amount of heating of the battery 108 during rapid charging of the battery 108, e.g., high voltage charging, the cooling system 110 external to the vehicle 102 can be connected with the cooling circuit/cells 122 of the battery 108. The cooling system 110 can push high volumes of coolant through the battery cooling circuit/cells 122, to allow for a high voltage, e.g., a rapid charge procedure, while reducing a risk of overheating and/or degrading the battery 108 during charging. If the cooling system 110 is connected with the cooling circuit/cells 122 native to the vehicle 102, the coolant 115 used can be compatible with a coolant of the vehicle 102.

In some examples, the charging station 100 provides direct current (DC) to the battery 108 to avoiding the vehicle alternating current (AC) charger that plugs into a wall. In other examples, AC charging can be used. In some examples, rapid charge provides a voltage greater than 220V DC, and more particularly greater than 400V DC. The charger 104 can also be rated in kW, >30 kw. To avoid crashing a power grid, a buffer can be used, e.g., large batteries that charge from the grid slowly and store from hundreds to Megawatts of power to supply the chargers 104 quickly. The charging station 100 can also be used as magnitude of power increases for charging. In some examples, the charging station 100 can provide rapid charging of SAE J1772 Level 3 or Combo Charging System (CCS), and new levels as developed, and for European IEC 62196 charging modes of Mode 4, and new levels as developed. Other vehicle types charged by the charging station 100 are also possible.

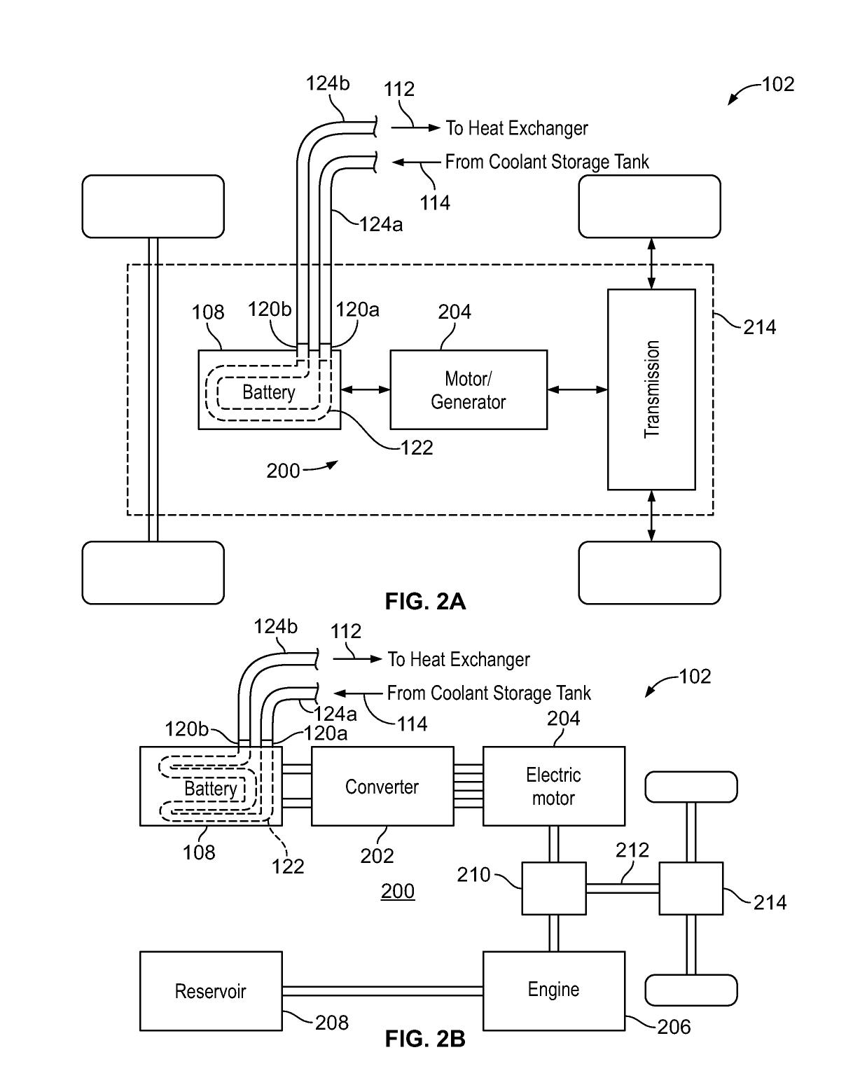

FIGS. 2A and 2B are block diagrams of an example drive train 200 of the vehicle 102. In FIG. 2A, in an electric vehicle, the battery 108 of the drive train 200 can power an electric motor/generator 204 to drive the vehicle 102. In FIG. 2B, in a hybrid vehicle, the vehicle 102 can also include a converter 202, an engine 206 and reservoir 208 for containing fuel, e.g., gasoline, diesel, jet fuel, etc., to power the engine 206. The electric motor 204 and the engine 206 can both individually drive the vehicle 102, or both the electric motor 204 and the engine 206 can be coupled jointly to a transmission 210 giving drive to the vehicle 102. The electric motor 204 and the engine 206 may be applied to the same coupler 212, for example with the electric motor 204 connected between the engine 206 and transmission 214, turning at equal speeds and the torques adding up with the electric motor 204 adding or subtracting torque to the system as necessary. The hybrid can also rely on regenerative braking from generator and the engine 206 can also act as a generator for supplemental recharging. Additional or alternative types of hybrids include, but are not limited to, through-the-road hybrids, series hybrids, power-split or series-parallel hybrids, micro hybrids, mild hybrids, full hybrids, plug-in hybrids, electric fuel cell hybrids, pneumatic hybrids, etc. In the electric vehicle and the hybrid vehicle, the battery 108 can include couplers 120a, 120 for connecting to the cooling circuit/cells 122 to the external cooling systems 110, for rapid charging of the vehicle 102.

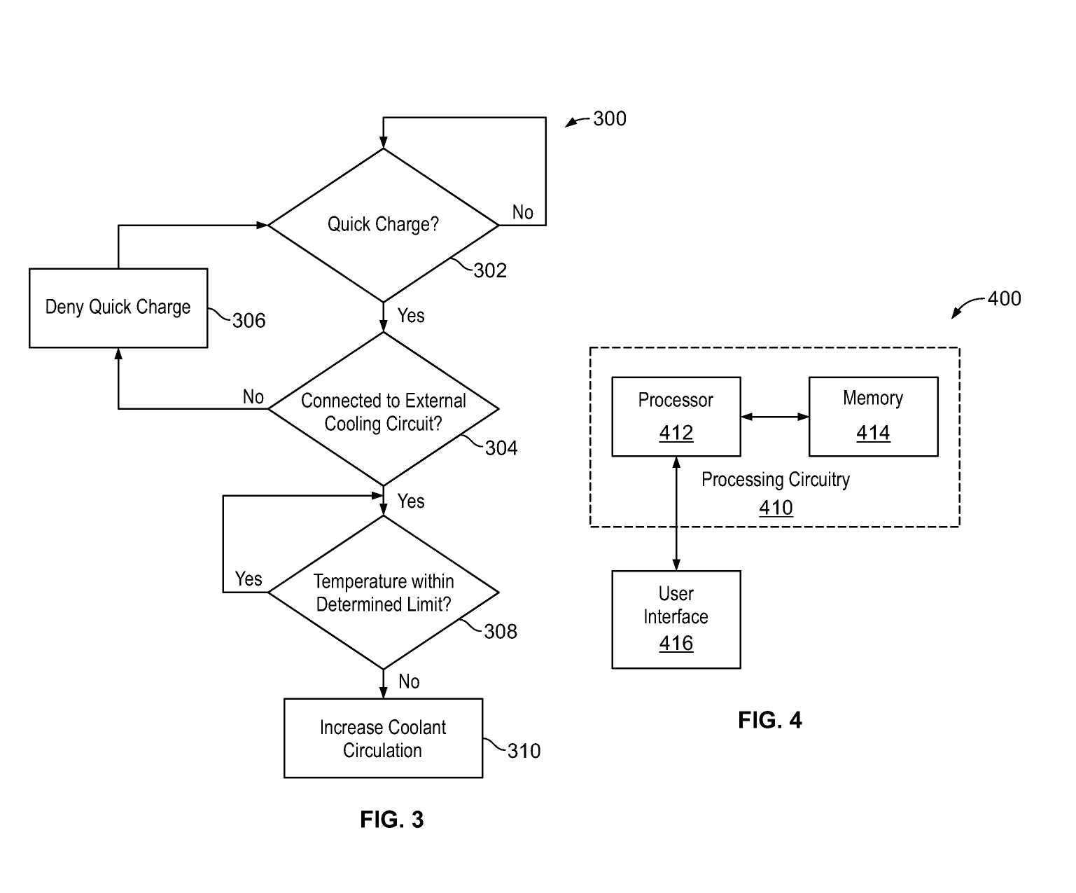

FIG. 3 is a flowchart 300 of an example process for charging batteries 108. In some examples, the control unit 106 can determine if the charger 104 is requested to perform a rapid charge, e.g., high voltage charging of the battery 108 (302). When a rapid charge is requested, the control unit 106 can determine if the cooling circuit/cells 122 for the battery 108 of the vehicle 102 is connected with the external cooling system 110 (304). In some examples, the control unit 106 can deny a rapid charge if the cooling circuit/cells 122 are not connected with the external cooling system 110 (306). The control unit 106 allows a rapid charge if the cooling circuit/cells 122 are connected with the external cooling system 110. During rapid charge, the thermostat and control unit 118 can determine if a temperature of the coolant 115, battery 108 and/or environment around the battery 108 is within a determined threshold (308). In some examples, the thermostat and control unit 118 ensures that the temperature stays below a determined threshold, e.g., around room temperature. The thermostat and control unit 118 can control operation of the pump 116 to supply an increased flow of coolant 115 to the cooling circuit/cells 122 as needed to control the temperature of the battery 108 below the determined threshold during charging, e.g., in combination with or instead of having to slow down charging as the temperature reaches the threshold (310). The thermostat and control unit 118 can control operation of the pump 116 to supply a decreased flow of coolant 115 to the cooling circuit/cells 122 when the temperature of the battery 108 is below the determined threshold during charging. In some examples, the heat exchanger 112, storage tank 114 and circulation pump 116 are sized to maintain the temperature of the battery 108 below the threshold during charging, e.g., rapid charge.

FIG. 4 is a block diagram of an example computing device 400. The control unit 106 and/or thermostat and control unit 118 may be implemented in many different ways in many different combinations of hardware, software firmware, or any combination thereof. In one example, the computing device 400 may enable the secure databases. It will be appreciated that the components, devices or elements illustrated in and described with respect to FIG. 4 may not be mandatory and thus some may be omitted in certain embodiments. Additionally, some embodiments may include further or different components, devices or elements beyond those illustrated in and described with respect to FIG. 4.

In some example embodiments, the computing device 400 may include processing circuitry 410 that is configurable to perform actions in accordance with one or more example embodiments disclosed herein. In this regard, the processing circuitry 410 may be configured to perform and/or control performance of one or more functionalities of the charging station 100. The processing circuitry 410 may be configured to perform data processing, application execution and/or other processing and management services according to one or more example embodiments. In some embodiments, the computing device 400 or a portion(s) or component(s) thereof, such as the processing circuitry 410, may include one or more chipsets and/or other components that may be provided by integrated circuits.

In some example embodiments, the processing circuitry 410 may include a processor 412 and, in some embodiments, such as that illustrated in FIG. 4, may further include memory 414. The processor 412 may be embodied in a variety of forms. For example, the processor 412 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 412 may comprise a plurality of processors. The plurality of processors may be in operative communication with each other and may be collectively configured to perform one or more functionalities of the computing device 400 as described herein. In some example embodiments, the processor 412 may be configured to execute instructions that may be stored in the memory 414 or that may be otherwise accessible to the processor 412. As such, whether configured by hardware or by a combination of hardware and software, the processor 412 is capable of performing operations according to various embodiments while configured accordingly.

In some example embodiments, the memory 414 may include one or more memory devices. Memory 414 may include fixed and/or removable memory devices. In some embodiments, the memory 414 may provide a non-transitory computer-readable storage medium that may store computer program instructions that may be executed by the processor 412. In this regard, the memory 414 may be configured to store information, data, applications, instructions and/or the like for enabling the computing device 400 to carry out various functions in accordance with one or more example embodiments. In some embodiments, the memory 414 may be in communication with one or more of the processor 412, the user interface 416 for passing information among components of the computing device 400.

It is noted that the terms “substantially” and “about” may be utilized herein to represent an inherent degree of uncertainty that can be attributed to any quantitative comparison, value, measurement, or other representation. These terms are also utilized herein to represent a degree by which a quantitative representation may vary from a stated reference without resulting in a change in the basic function of the subject matter at issue.

While particular examples above have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A battery charging station, comprising:
a charger connected with a battery of a vehicle; and
a cooling system connected external to the vehicle, the cooling system connected with the vehicle during charging of the battery to prevent overheating of the battery during charging.

2. The battery charging station of claim 1, further comprising:
a coolant storage tank containing coolant; and
a pump connected with the coolant storage tank and the battery of the vehicle, the pump configured to supply coolant from the coolant storage tank to the battery of the vehicle.

3. The battery charging station of claim 2, further comprising:
a heat exchanger connected with the battery of the vehicle and coolant storage tank, the heat exchanger configured to remove heat from the coolant returned to the coolant storage tank.

4. The battery charging station of claim 1, further comprising:
a control unit connected with the charger, the control unit configured to deny a high voltage charge if the cooling system is not connected with the vehicle.

5. The battery charging station of claim 1, further comprising:
a thermostat and control unit connected with the pump, the thermostat and control unit configured to control an amount of coolant supplied to the vehicle based on a temperature of the battery or the coolant.

6. The battery charging station of claim 5, wherein the thermostat and control unit controls operation of the pump to supply an increased flow of coolant to a cooling circuit of the vehicle to control the temperature of the battery below the determined threshold during charging.

7. The battery charging station of claim 1 further including a quick release connector to connect the pump and the heat exchanger to the battery.

8. The battery charging station of claim 1, where the cooling system further includes a coolant, where the coolant is the same as, or equivalent to, a coolant native to the vehicle.

9. A method, comprising:
receiving a request for a rapid charging of a vehicle;
determining if the vehicle is connected with a cooling system external to the vehicle; and
allowing the rapid charging if the vehicle is connected with the cooling system external to the vehicle.

10. The method of claim 9, further comprising:
connecting a heat exchanger, a coolant storage tank and a pump external to the vehicle.

11. The method of claim 10, further comprising:
determining if a temperature of at least one of a coolant, a battery and an environment around the battery of the vehicle is within a determined threshold.

12. The method of claim 11, wherein the determined threshold comprises around room temperature.

13. The method of claim 10, further comprising:
controlling operation of the pump to supply an increased flow of coolant to a cooling circuit of the vehicle to control a temperature of a battery of the vehicle below the determined threshold during rapid charging.

14. The method of claim 12, further comprising:
decreasing a flow of coolant to the cooling circuit when the temperature of the battery is below the determined threshold during rapid charging.

15. A vehicle, comprising:
a battery;
a cooling circuit connected with the battery;
a first quick release connector to connect the cooling circuit with a heat exchanger and a second quick release connector to connect the cooling circuit with a coolant storage tank.

16. The vehicle of claim 15, further comprising:
a control unit to determine if the cooling circuit is connected with a cooling system external to the vehicle and allow a rapid charging if the cooling circuit is connected with the cooling system.

17. The vehicle of claim 15, further comprising:
a pump to supply coolant from a coolant storage tank to the cooling circuit.

18. The vehicle of claim 17, further comprising:
a thermostat and control unit connected with the pump to control operation of the pump to supply an increased flow of coolant to the cooling circuit to maintain a temperature of the battery below a determined threshold during rapid charging.

19. The vehicle of claim 18, wherein the thermostat and control unit further controls operation of the pump to supply a decreased flow of coolant to the cooling circuit when the temperature of the battery is below the determined threshold during rapid charging.

20. The vehicle of claim 15, further comprising:
a heat exchanger to remove heat from a coolant of the cooling circuit before the coolant is returned to a coolant storage tank external to the vehicle.
